(19) United States
(12) Patent Application Publication
(10) Pub. No.: US 2025/0013876 A1
(43) Pub. Date: Jan. 9, 2025

(54) METHOD AND APPARATUS FOR TRAINING A LARGE LANGUAGE MODEL, AND MEDIUM

(71) Applicant: Beijing Baidu Netcom Science Technology Co., Ltd., Beijing (CN)

(72) Inventors: Xianwei XUE, Beijing (CN); Qiutong PAN, Beijing (CN); Jinchang LUO, Beijing (CN); Bolei HE, Beijing (CN); Wei HE, Beijing (CN)

(21) Appl. No.: 18/889,928

(22) Filed: Sep. 19, 2024

(30) Foreign Application Priority Data
Jun. 20, 2023 (CN) 202410804722.6

(51) Int. Cl. G06N 3/0985; G06F 40/30; G06F 40/40; G06N 3/0475

(52) U.S. Cl. CPC G06N 3/0985; G06F 40/30; G06F 40/40; G06N 3/0475

(57) ABSTRACT

An apparatus for training a large language model includes: at least one sample text instruction is input into a target large language model to obtain at least one standard response text, and the at least one sample text instruction is input into a large language model to be trained to obtain at least one predicted response text. A first sample response text is determined from the at least one standard response text according to the score difference between a first quality score of a standard response text and a second quality score of a predicted response text. A first target training sample is generated according to the first sample response text and a sample text instruction corresponding to the first sample response text, and a training dataset is constructed according to the first target training sample.

### CROSS-REFERENCE TO RELATED APPLICATION

This application claims priority to Chinese Patent Application No. 202410804722.6 filed Jun. 20, 2024, the disclosure of which is incorporated herein by reference in its entirety.

### TECHNICAL FIELD

The present disclosure relates to the field of computer technology, specifically to technical fields such as pre-training, large models, large language models, model distillation, fine-tuning, optimization, micro-adjustment, transformer, conversational, generative, and generative models. In particular, the present disclosure relates to a method and apparatus for training a large language model, and a medium.

### BACKGROUND

With the development of research on large language models, researchers have begun using closed-source models to provide data for training open-source models. This is a method known as model distillation. Model distillation addresses the challenge of acquiring training data for large language models at the data level and offers a way for open-source models to replicate the capabilities of closed-source models.

In current research, the model being distilled is referred to as the teacher model, while the distilled model is referred to as the student model. The entire process mimics the way a teacher guides a student. This method enables the student model to replicate the capabilities of the teacher model by learning the thought processes and response patterns of the teacher model.

Existing distillation schemes do not intervene in the training samples generated by the teacher model; instead, they directly construct a training dataset according to all training samples produced by the teacher model for training the student model.

### SUMMARY

The present disclosure provides a method and apparatus for training a large language model, a device, a medium, and a product for improving the training efficiency of the large language model.

According to one aspect of the present disclosure, a method for training a large language model is provided. The method includes steps described below.

At least one sample text instruction is input into a target large language model to obtain at least one standard response text, and the at least one sample text instruction is input into a large language model to be trained to obtain at least one predicted response text; where the target large language model is a pre-trained large language model.

A first sample response text is determined from the at least one standard response text according to the score difference between a first quality score of a standard response text of the at least one standard response text and a second quality score of a predicted response text of the at least one predicted response text.

A first target training sample is generated according to the first sample response text and a sample text instruction of the at least one sample text instruction corresponding to the first sample response text, and a training dataset is constructed according to the first target training sample; where the training dataset is used to train the large language model to be trained.

According to another aspect of the present disclosure, an apparatus for training a large language model is provided. The apparatus includes a response text acquisition module, a score difference determination module, and a training dataset construction module.

The response text acquisition module is configured to input at least one sample text instruction into a target large language model to obtain at least one standard response text and input the at least one sample text instruction into a large language model to be trained to obtain at least one predicted response text; where the target large language model is a pre-trained large language model.

The score difference determination module is configured to determine a first sample response text from the at least one standard response text according to the score difference between a first quality score of a standard response text of the at least one standard response text and a second quality score of a predicted response text of the at least one predicted response text.

The training dataset construction module is configured to generate a first target training sample according to the first sample response text and a sample text instruction of the at least one sample text instruction corresponding to the first sample response text and construct a training dataset according to the first target training sample; where the training dataset is used to train the large language model to be trained.

According to another aspect of the present disclosure, an electronic device is provided.

The electronic device includes at least one processor and a memory communicatively connected to the at least one processor.

The memory stores instructions executable by the at least one processor, and the instructions are executed by the at least one processor to cause the at least one processor to perform any method in the present disclosure.

According to another aspect of the present disclosure, a non-transitory computer-readable storage medium is provided. The storage medium stores computer instructions for causing a computer to perform any method in the present disclosure.

According to another aspect of the present disclosure, a computer program product is provided. The computer program product includes a computer program that, when executed by a processor, performs any method in the present disclosure.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure. In the drawings:

FIG. 1 is a flowchart illustrating a method for training certain large language models according to an embodiment of the present disclosure.

FIG. 2A is a flowchart illustrating a method for training other large language models according to an embodiment of the present disclosure.

FIG. 2B is a schematic diagram of the training of certain large language models according to an embodiment of the present disclosure.

FIG. 3 is a flowchart illustrating certain supplementation methods for training samples according to an embodiment of the present disclosure.

FIG. 4 is a diagram illustrating the structure of an apparatus for training certain large language models according to an embodiment of the present disclosure.

FIG. 5 is a block diagram of an electronic device for implementing a method for training a large language model according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

Recent developments in large language models, such as GPT-4, have demonstrated impressive capabilities. Current research primarily focuses on utilizing powerful closed-source large language models to execute instructions provided by humans. However, in certain application scenarios, closed-source models exhibit inefficient operational performance and struggle to effectively handle tasks specific to particular business domains. In such cases, training and task completion often necessitate the use of an open-source large language model. The training of large language models requires substantial data support, and this training data often necessitates significant manual effort for annotation before the data can be utilized. Given the limitations of annotated training data, it is challenging for open-source models to achieve the same good results as closed source models.

With the development of research on large language models, researchers have begun using closed-source models to provide data for training open-source models, a method known as model distillation. Model distillation addresses the challenge of acquiring training data for large language models at the data level and offers a way for open-source models to replicate the capabilities of closed-source models.

In current research, the model being distilled is referred to as the teacher model, while the distilled model is referred to as the student model. The entire process mimics the way a teacher guides a student. Model distillation is categorized into two types: white-box distillation and black-box distillation. White-box distillation requires access to the model parameters of both the teacher and student models, which is often impractical when dealing with closed-source models. Therefore, the industry typically employs black-box distillation. Black-box distillation does not require access to the parameters of the teacher model; black-box distillation only requires the teacher model to respond to instructions based on training data to generate training data. This method allows the student model to learn the thought processes and response patterns of the teacher model through responses, thereby replicating the capabilities of the teacher model.

Existing distillation schemes do not intervene in the training samples generated by the teacher model; instead, they directly construct a training dataset according to all training samples produced by the teacher model for training the student model. However, for the training samples needed in the model training process, only a portion of the training samples typically contributes to achieving optimal training results. The remaining training samples, while still involved in the model training, bring little training effect. Therefore, without intervention in the training samples, it is difficult to achieve satisfactory training performance for the student model using a limited number of training samples, which undoubtedly results in lower training efficiency.

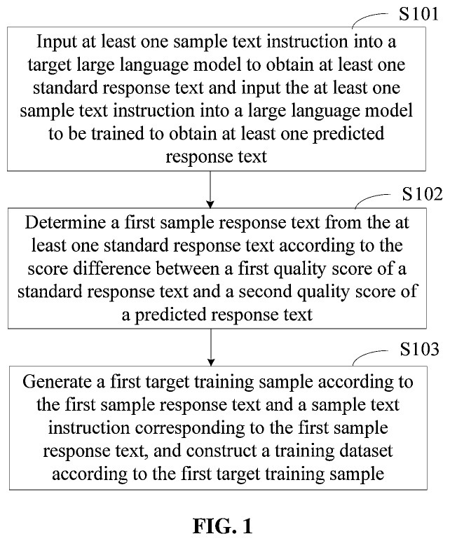

FIG. 1 is a flowchart illustrating a method for training certain large language models according to an embodiment of the present disclosure. This embodiment is applicable to situations where training samples generated by a pre-trained large language model are used for training a large language model to be trained. The method in this embodiment may be performed by an apparatus for training a large language model according to an embodiment of the present disclosure. The apparatus may be implemented by software and/or hardware and integrated into any electronic device having a computing capability, such as a server.

As shown in FIG. 1, the method for training a large language model disclosed in this embodiment may include steps described below.

In S101, at least one sample text instruction is input into a target large language model to obtain at least one standard response text, and the at least one sample text instruction is input into a large language model to be trained to obtain at least one predicted response text.

In this context, the target large language model refers to a pre-trained large language model, also known as the teacher model, while the large language model to be trained refers to a large language model that is in the model training phase and has not been trained yet, also known as the student model. A large language model, in this context, denotes a deep learning model with a massive parameter scale, capable of generating or understanding natural language text. The large language model can handle various natural language tasks, such as text classification, question answering, and dialogue. Typically, the large language model has a parameter scale reaching hundreds of billions.

In an embodiment, at least one sample text instruction is acquired. This sample text instruction refers to a model input text used to drive the target large language model and the large language model to be trained to generate a response text, such as “share an article” or “what is a large language model”. The specific content of the sample text instruction is not limited in this embodiment.

Each sample text instruction is input into the target large language model. The target large language model uses the learned thought and response patterns to produce corresponding response texts for each sample text instruction as standard response texts. It can be understood that since the target large language model is a fully trained large language model, the model performance is usually excellent. Therefore, the standard response texts output by the target large language model for sample text instructions are typically highly relevant to the sample text instructions and of high quality.

Meanwhile, each sample text instruction is input into the large language model to be trained. The large language model to be trained uses the learned thought and response patterns to produce corresponding response texts for each sample text instruction as predicted response texts. It can be understood that since the large language model to be trained has not been trained yet in the model training phase and the model performance does not reach the optimal state, the quality of the predicted response texts generated in response to sample text instructions by the large language model to be trained is often difficult to guarantee. Specifically, if the large language model to be trained is in the early training phase, the quality of each predicted response text generated by the model may be poor. However, as the model training progresses, the model performance of the large language model to be trained improves continuously, leading to higher quality of each predicted response text output by the large language model to be trained.

It is important to note that in this embodiment, the same batch of sample text instructions is separately input into both the target large language model and the large language model to be trained for processing, that is, the model input data of the target large language model and the large language model to be trained is the same.

At least one sample text instruction is input into a target large language model to obtain at least one standard response text, and the at least one sample text instruction is input into a large language model to be trained to obtain at least one predicted response text. In this manner, response texts given by the target large language model and the large language model to be trained for the same batch of sample text commands are collected. This lays a data foundation for evaluating the quality differences between the response texts of the two models.

In S102, a first sample response text is determined from the at least one standard response text according to the score difference between a first quality score of a standard response text and a second quality score of a predicted response text.

The quality score is utilized to measure the quality of the response text generated by the large language model. The quality of the response text is reflected in at least one of the following aspects: “completeness of content,” “clarity of content,” “comprehensiveness of content,” and “relevance” of the response text to the text instruction. It can be understood that a higher quality score indicates a higher quality of the response text generated by the large language model, that is, the response text is more complete, clearer, more comprehensive, and/or more relevant to the text instruction; conversely, a lower quality score signifies a lower quality of the response text generated by the large language model, that is, the response text is more incomplete, unclear, limited, and/or deviates more from the text instruction.

It can be understood that the score difference reflects the quality difference between different response texts. A larger score difference indicates a greater quality difference between different response texts, while a smaller score difference indicates a smaller quality difference between different response texts. The first sample response text refers to the standard response text that can yield better training results for the large language model to be trained.

In an embodiment, each standard response text is input into a quality scoring model, and each standard response text is scored using the quality scoring model to obtain first quality scores of each standard response text. Additionally, each predicted response text is input into the quality scoring model, and each predicted response text is scored using the quality scoring model to obtain second quality scores of each predicted response text. The quality scoring model may either be an independently trained scoring model or a scoring model integrated into the target large language model, that is, the target large language model may serve both as a teacher model to guide the training of the large language model to be trained and as the quality scoring model.

The difference calculation is performed between a first quality score of a standard response text and a second quality score of a predicted response text corresponding to the same sample text instruction to determine the score difference between the standard response text and the predicted response text corresponding to the same sample text instruction. It can be understood that if the score difference between the standard response text and the predicted response text corresponding to the same sample text instruction is large, it indicates that for the same sample text instruction, the first quality score of the standard response text generated by the target large language model is significantly superior to the second quality score of the predicted response text generated by the large language model to be trained. That is, the large language model to be trained has a weaker processing ability for the sample text instruction and needs to learn to mimic the thought processes and response patterns of the target large language model for the sample text instruction. Therefore, the standard response text corresponding to the sample text instruction is designated as the first sample response text, thus forming the first target training sample for the training of the large language model to be trained. If the score difference between the standard response text and the predicted response text corresponding to the same sample text instruction is small, it indicates that for the same sample text instruction, the first quality score of the standard response text generated by the target large language model is converging with the second quality score of the predicted response text generated by the large language model to be trained. That is, the processing ability of the large language model to be trained for the sample text instruction is already similar to that of the target large language model, and the large language model to be trained is not required to learn to mimic the thought processes and response patterns of the target large language model for the sample text instruction. In other words, the standard response text corresponding to the sample text instruction has little training effect on the large language model to be trained and is not used as the first sample response text.

A first sample response text is determined from the at least one standard response text according to the score difference between a first quality score of a standard response text and a second quality score of a predicted response text. Thus, based on score differences, standard response texts are filtered to select those yielding better training results for the large language model to be trained as the first sample response texts.

In S103, a first target training sample is generated according to the first sample response text and a sample text instruction corresponding to the first sample response text, and a training dataset is constructed according to the first target training sample.

The training dataset is used to train the large language model to be trained.

In an embodiment, according to the correspondence between each sample text instruction and standard response texts, sample text instructions corresponding to each first sample response text are determined. For example, assuming that a first sample response text is “aabbcc”, and this first sample response text is generated by inputting the sample text instruction “xyz” into the target large language model, that is, the sample text instruction “xyz” corresponds to the first sample response text “aabbcc”. Thus, the sample text instruction “xyz” is determined as the sample text instruction corresponding to the first sample response text “aabbcc”.

The determined first sample response text and the sample text instruction corresponding to the first sample response text are combined, and a first target training sample is generated according to the combination result. The preceding example continues to be used for explanation. Given that the first sample response text is “aabbcc” and the sample text instruction “xyz” corresponds to the first sample response text “aabbcc”, “xyz” and “aabbcc” are combined to form a first target training sample. The combination method may be in the form of a key-value (KV) pair, where the key is “xyz” and the value is “aabbcc”.

A training dataset is constructed according to each composed first target training sample, and the training dataset is then used to train the large language model to be trained to learn and mimic the thought processes and response patterns of the target large language model and optimize the model performance of the large language model to be trained.

Since the first sample response text is selected according to the score difference, it can be understood that if the score difference between the standard response text and the predicted response text corresponding to the same sample text instruction is large, it indicates that for the same sample text instruction, the first quality score of the standard response text generated by the target large language model is significantly superior to the second quality score of the predicted response text generated by the large language model to be trained. That is, the large language model to be trained has a weaker processing ability for the sample text instruction and needs to learn to mimic the thought processes and response patterns of the target large language model for the sample text instruction. Therefore, the standard response text corresponding to the sample text instruction is designated as the first sample response text. Then, a first target training sample is generated according to the first sample response text and a sample text instruction corresponding to the first sample response text, and a training dataset is constructed according to the first target training sample.

From the analysis above, it is evident that the large language model to be trained has a weaker processing capability for the sample text instruction in the first sample response text. Therefore, constructing the training dataset according to the first target training sample generated by the first sample response text provides richer gradient information during the backpropagation phase of model training, leading to larger updates to the model parameters of the large language model to be trained and ensuring better training outcomes for the large language model to be trained. Moreover, compared to the related art where all training samples generated by the teacher model are used as training data, this disclosure only selects the first target training samples to construct the training dataset. This method undoubtedly enhances the efficiency of model training while ensuring training effectiveness, facilitating high-quality training with a smaller amount of training data.

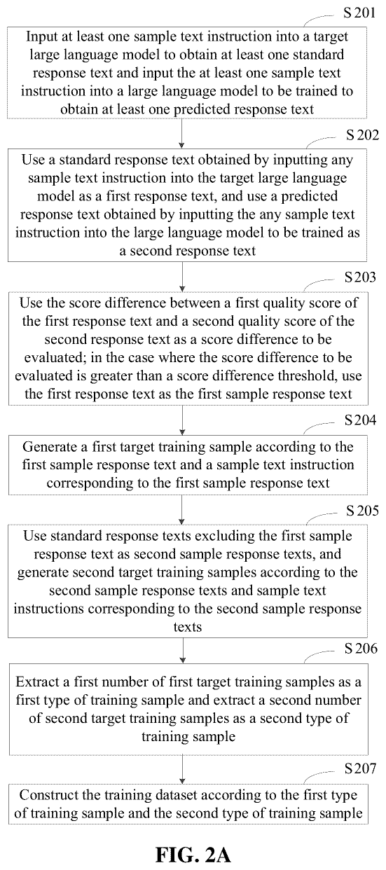

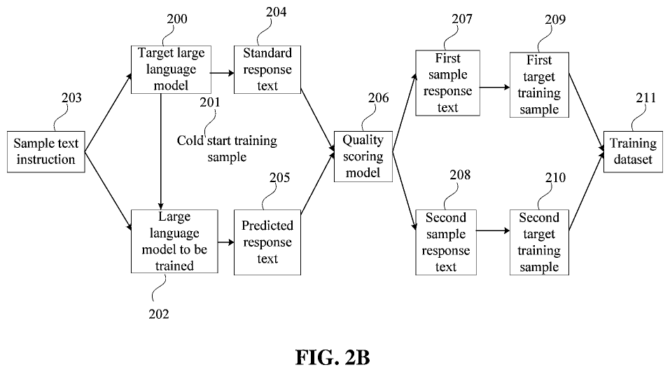

FIG. 2A is a flowchart illustrating a method for training other large language models according to an embodiment of the present disclosure. The training method may be used to further optimize and expand the preceding technical solutions and may be combined with the preceding various optional embodiments.

As shown in FIG. 2A, the method for training a large language model disclosed in this embodiment may include steps described below.

In S201, at least one sample text instruction is input into a target large language model to obtain at least one standard response text, and the at least one sample text instruction is input into a large language model to be trained to obtain at least one predicted response text.

In this context, the target large language model refers to a pre-trained large language mode.

In S202, a standard response text obtained by inputting any sample text instruction into the target large language model is used as a first response text, and a predicted response text obtained by inputting the any sample text instruction into the large language model to be trained is used as a second response text.

Illustratively, it is assumed that the standard response text obtained by inputting the sample text instruction “abc” into the target large language model is “qwe”, and the predicted response text obtained by inputting the sample text instruction “abc” into the large language model to be trained is “ewq”. Then, “qwe” is used as the first response text, while “ewq” is used as the second response text.

In S203, the score difference between a first quality score of the first response text and a second quality score of the second response text is used as a score difference to be evaluated; in the case where the score difference to be evaluated is greater than a score difference threshold, the first response text is used as the first sample response text.

The score difference threshold is used to evaluate the difference in processing capabilities between the large language model to be trained and the target large language model for the same sample text instruction. It can be understood that if the score difference to be evaluated is greater than the score difference threshold, it indicates that for the same sample text instruction, the first quality score of the first response text generated by the target large language model is significantly superior to the second quality score of the second response text generated by the large language model to be trained. That is, the large language model to be trained has a weaker processing capability for the given sample text instruction. If the score difference to be evaluated is less than or equal to the score difference threshold, it indicates that for the same sample text instruction, the first quality score of the first response text generated by the target large language model is converging with the second quality score of the second response text generated by the large language model to be trained. That is, the processing capability of the large language model to be trained for the sample text instruction is already similar to that of the target large language model. The score difference threshold may be set according to actual business requirements. For example, when the quality score is on a five-point scale, the score difference threshold may be set to one point.

The preceding example continues to be used for explanation. It is assumed that the first quality score of the first response text “qwe” is 4 points, while the second quality score of the second response text “ewq” is 2 points. Therefore, the score difference to be evaluated is 2 points. Assuming that the score difference threshold is 1 point, the first response text “qwe” is used as the first sample response text.

A standard response text obtained by inputting any sample text instruction into the target large language model is used as a first response text, and a predicted response text obtained by inputting the any sample text instruction into the large language model to be trained is used as a second response text. The score difference between a first quality score of the first response text and a second quality score of the second response text is used as a score difference to be evaluated. In the case where the score difference to be evaluated is greater than a score difference threshold, the first response text is used as the first sample response text. Thus, the quantitative evaluation of the quality differences between the first and second response texts is enabled, and it is beneficial for the rapid identification of the first sample response text that can yield better training outcomes for the large language model to be trained.

In S204, a first target training sample is generated according to the first sample response text and a sample text instruction corresponding to the first sample response text.

In S205, standard response texts excluding the first sample response text are used as second sample response texts, and second target training samples are generated according to the second sample response texts and sample text instructions corresponding to the second sample response texts.

The second sample response texts refer to the standard response texts (first response texts) whose score differences to be evaluated are less than or equal to the score difference threshold, that is, the standard response texts (first response texts) other than the first sample response text are used as the second sample response texts.

In S206, a first number of first target training samples are extracted as a first type of training sample, and a second number of second target training samples are extracted as a second type of training sample.

In S207, the training dataset is constructed according to the first type of training sample and the second type of training sample.

During the research and development process, it is found that although the first target training samples can produce good training results, constructing the training dataset solely according to the first target training samples leads to suboptimal model training performance. Conversely, introducing some second target training samples into the training dataset, in addition to the first target training samples, can achieve optimal model training performance.

In an embodiment, a first number of first target training samples are extracted from first target training samples as the first type of training sample, and a second number of second target training samples are extracted from the second target training samples as the second type of training sample. The ratio between the first number and the second number is a preset ratio. The preset ratio may be set and adjusted according to the model training performance.

Standard response texts excluding the first sample response text are used as second sample response texts, and second target training samples are generated according to the second sample response texts and sample text instructions corresponding to the second sample response texts. A first number of first target training samples are extracted as a first type of training sample, and a second number of second target training samples are extracted as a second type of training sample, where the ratio between the first number and the second number is a preset ratio. The training dataset is constructed according to the first type of training sample and the second type of training sample, thereby optimizing the training samples contained in the training dataset. This ensures that the training dataset contains both the first type and the second type of training samples in a preset ratio. Thus, it is ensured that the large language model to be trained is trained with an optimized training dataset, and the training performance of the large language model to be trained can be optimal.

Optionally, the preset ratio is one to one.

Illustratively, it is assumed that 50 first target training samples are extracted from the first target training samples as the first type of training sample, and 50 second target training samples are extracted from the second target training samples as the second type of training sample, the training dataset is constructed according to these 50 first type of training sample and 50 second type of training sample.

The preset ratio is set to one to one. Thus, it is ensured that the large language model to be trained is trained with an optimized training dataset, and the training performance of the large language model to be trained can be optimal.

Optionally, before determining the score difference between the first quality score of the first response text and the second quality score of the second response text, the method also includes the following:

A: The first response text and the any sample text instruction are input into a quality scoring model to obtain a first initial score, and the second response text and the any sample text instruction are input into the quality scoring model to obtain a second initial score.

In an embodiment, the first response text and the sample text instruction are first input into the quality scoring model, and the quality scoring model is used to score the first response text to obtain a first initial score for the first response text. After obtaining the first initial score for the first response text, the second response text and the sample text instruction are input into the quality scoring model, and the quality scoring model is used to score the second response text to obtain a second initial score for the second response text.

B: The second response text and the any sample text instruction are input into the quality scoring model to obtain a third initial score, and the first response text and the any sample text instruction are input into the quality scoring model to obtain a fourth initial score.

In an embodiment, the second response text and the sample text instruction are first input into the quality scoring model, and the quality scoring model is used to score the second response text to obtain a third initial score for the second response text. After obtaining the third initial score for the second response text, the first response text and the sample text instruction are input into the quality scoring model, and the quality scoring model is used to score the first response text to obtain a fourth initial score for the first response text.

C: The first quality score is determined according to the average of the first initial score and the fourth initial score, and the second quality score is determined according to the average of the second initial score and the third initial score.

Illustratively, assuming that the first initial score and the fourth initial score are A1 and A4, respectively, and the second initial score and the third initial score are A2 and A3, respectively, then the first quality score for the first response text is (A1+A4)/2, and the second quality score for the second response text is (A2+A3)/2.

Since the quality scoring model is a large language model and the order of model input data may affect the model output data, thus, first, the first response text and the sample text instruction are input into the quality scoring model to obtain a first initial score, and then the second response text and the sample text instruction are input into the quality scoring model to obtain a second initial score. Next, the second response text and the sample text instruction are input into the quality scoring model first to obtain a third initial score, and then the first response text and the sample text instruction are input into the quality scoring model to obtain a fourth initial score. The first quality score is determined according to the average of the first initial score and the fourth initial score, and the second quality score is determined according to the average of the second initial score and the third initial score. This method helps to minimize the impact of input order on the scoring results, ensuring the accuracy and reliability of the first and second quality scores.

Optionally, before inputting the at least one sample text instruction into the large language model to be trained to obtain the at least one predicted response text, the method also includes the following:

At least one initial text instruction is input into the target large language model to obtain at least one initial response text; a cold start training sample is generated according to the at least one initial text instruction and the at least one initial response text, and the cold start training sample is used to pre-train the large language model to be trained.

The initial text instruction refers to a text instruction obtained during the pre-training phase. The initial response text refers to a response text generated by inputting the initial text instruction into the target large language model. Cold start training is composed of the initial text instruction and initial response text, representing the sample used for pre-training the large language model to be trained in the pre-training phase.

In an embodiment, during the pre-training phase, at least one initial text instruction is input into the target large language model to generate at least one initial response text. Cold start training samples are created according to each initial text instruction and each corresponding initial response text. The large language model to be trained is pre-trained using cold start training samples by methods including supervised fine-tuning (SFT), allowing the large language model to be trained to acquire basic instruction-response capabilities. It can be understood that during the pre-training phase, the large language model to be trained can already respond to specific instructions, but the performance is not yet optimal. Therefore, a formal training phase needs to be triggered.

At least one initial text instruction is input into the target large language model to obtain at least one initial response text; a cold start training sample is generated according to the at least one initial text instruction and the at least one initial response text, and the cold start training sample is used to pre-train the large language model to be trained. In this manner, it is ensured that the large language model to be trained has basic instruction-response capabilities before formal training, thus facilitating smooth execution of the subsequent formal training phase.

FIG. 2B is a schematic diagram of the training of certain large language models according to an embodiment of the present disclosure. As shown in FIG. 2B, the target large language model 200 first produces cold start training samples 201 for pre-training the large language model to be trained 202. After pre-training, at least one sample text instruction 203 is input into both the target large language model 200 and the large language model to be trained 202 to generate at least one standard response text 204 and at least one predicted response text 205, respectively. The at least one standard response text 204 and at least one predicted response text 205 are input into a quality scoring model 206. According to the quality scores, first sample response texts 207 and second sample response texts 208 are selected. Then a first target training sample 209 is generated according to the first sample response texts 207, and a second target training sample 210 is generated according to the second sample response texts 208. Finally, a training dataset 211 is constructed according to the first target training sample 209 and the second target training sample 210.

FIG. 2B only explains the training process for the large language models. Detailed execution methods for each step may refer to the execution methods provided in each embodiment of the present disclosure and will not be repeated herein.

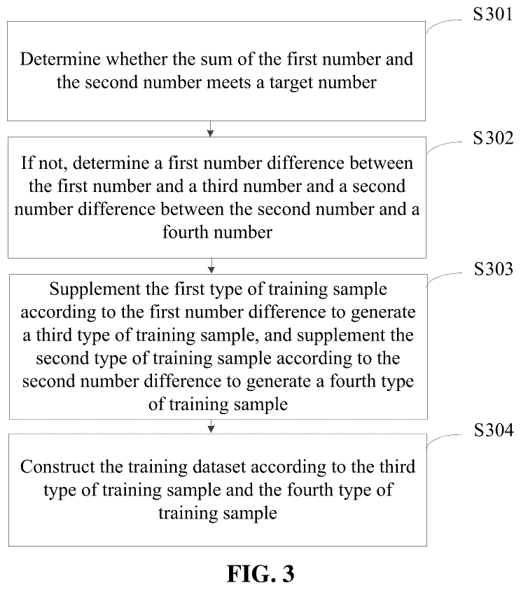

FIG. 3 is a flowchart illustrating certain supplementation methods for training samples according to an embodiment of the present disclosure. These methods may be used to further optimize and expand the “construct the training dataset according to the first type of training sample and the second type of training sample” mentioned in the preceding technical solutions and may be combined with the various optional embodiments described above.

As shown in FIG. 3, the supplementation methods for training samples disclosed in this embodiment may include the following:

In S301, it is determined whether the sum of the first number and the second number meets a target number.

The target number is the minimum number of training samples required for training the large language model to be trained. If the number of training samples is too small during training of the large language model to be trained, the model fails to converge. Therefore, a minimum number of training samples, that is, the target number, is empirically set for the large language model to be trained.

In an embodiment, the sum of the first number of first target training samples and the second number of second target training samples is determined and compared with the target number. If the sum is greater than or equal to the target number, it indicates that the target number is met; if the sum is less than the target number, it indicates that the target number is not met.

If the sum is greater than or equal to the target number, it indicates that the first and second target training samples are sufficient for the normal training of the large language model to be trained, and no processing is required for the first and second target training samples.

In S302, if not, a first number difference between the first number and a third number and a second number difference between the second number and a fourth number are determined.

The third number and the fourth number are determined according to the target number and the preset ratio. For example, assuming that the target number is 100 and the preset ratio between the first number and the second number is one to one, both the third number and the fourth number are 50. It can be understood that under the condition that the preset ratio between the first number and the second number remains unchanged, the third number represents the minimum number of the first type of training sample required for training the large language model to be trained, and the fourth number represents the minimum number of the second type of training sample required for training the large language model to be trained.

In an embodiment, if the sum of the first number and second number does not meet the target number, the first number difference is determined according to the first number and the third number, and the second number difference is determined according to the second number and the fourth number.

In S303, the first type of training sample is supplemented according to the first number difference to generate a third type of training sample, and the second type of training sample is supplemented according to the second number difference to generate a fourth type of training sample.

The first number difference represents the difference between the current first number of the first type of training sample and the minimum number (third number) of the first type of training sample required for training the large language model to be trained. The second number difference represents the difference between the current second number of the second type of training sample and the minimum number (fourth number) of the second type of training sample required for training the large language model to be trained.

In an embodiment, to ensure the normal execution of model training, the first type of training sample is supplemented according to the first number difference to generate a third type of training sample, and the second type of training sample is supplemented according to the second number difference to generate a fourth type of training sample. Thus, it is ensured that the sum of the number of the third type of training sample and the fourth type of training sample can meet the target number.

Optionally, supplementing the first type of training sample according to the first number difference to generate the third type of training sample includes the following:
(1) It is determined whether the number of first remaining samples is greater than or equal to the first number difference.

The first remaining samples are first target training samples excluding the first type of training sample.

In an embodiment, it is determined whether the number of first target training samples (first remaining samples) excluding the first type of training sample is greater than or equal to the first number difference. If so, it indicates that sufficient training samples exist in the first remaining samples to supplement the first type of training sample. In this case, the first target training samples are extracted from the first remaining samples according to the first number difference and supplemented into the first type of training sample.

For example, assuming that the number of first remaining samples is 30 and the first number difference is 10, then 10 first target training samples are extracted from the first remaining samples and supplemented into the first type of training sample.
(2) If not, sample simulation is performed according to attribute information of the first type of training sample to generate first simulated samples.

If the number of first remaining samples is less than the first number difference, it indicates that no sufficient training samples exist in the first remaining samples to supplement the first type of training sample. This situation often occurs in the later phase of model training, where the performance of the large language model to be trained continues to improve, resulting in fewer first target training samples. In this case, it is necessary to generate additional first simulation samples to supplement the first type of training sample. The number of first simulated samples is equal to the first number difference.

The attribute information includes at least one of a sample topic, sample content, or a sample format. Illustratively, the sample topic may include “finance,” “education,” and “technology”; the sample content refers to the specific sample content contained in the first type of training sample; the sample format may include “table”, “image”, and “chart”.

In an embodiment, the attribute information of each of the first type of training sample is determined, and a sample simulation method is used to perform sample simulation according to the attribute information to generate first simulated samples similar in attribute information to each of the first type of training sample.

In another embodiment, each of the first type of training sample and sample simulation instructions are input into a data generation model, and the first simulated samples are automatically output using the data generation model. The sample simulation instructions are used to guide the data generation model in acquiring the attribute information of each of the first type of training sample. For example, a sample simulation instruction may be as follows: “Generate data by imitating the following content, ensuring that the topic and content are similar to the following content, and the format is the same”.

The data generation model may be either an independently trained data generation model or a data generation model integrated within the target large language model, that is, the target large language model may serve as a teacher model to guide the training of the large language model to be trained, as a quality scoring model, or as a data generation model.
(3) The first simulated samples are supplemented into the first type of training sample to generate the third type of training sample.

It is determined whether the number of first remaining samples is greater than or equal to the first number difference; where the first remaining samples are first target training samples excluding the first type of training sample. If not, sample simulation is performed according to attribute information of the first type of training sample to generate first simulated samples. The number of first simulated samples is equal to the first number difference, and the attribute information includes at least one of a sample topic, sample content, or a sample format. The first simulated samples are supplemented into the first type of training sample to generate the third type of training sample. In this manner, it is ensured that when training samples are insufficient in the first remaining samples to supplement the first type of training sample, additional first simulated samples are generated to ensure that the expanded sample number meets the minimum number of training samples required for training. Meanwhile, it is also ensured that the ratio of the two types of training samples in the training dataset remains in the preset ratio, thereby ensuring the model training performance of the large language model to be trained.

Optionally, supplementing the second type of training sample according to the second number difference to generate the fourth type of training sample includes the following:
(1) It is determined whether the number of second remaining samples is greater than or equal to the second number difference.

The second remaining samples are second target training samples excluding the second type of training sample.

In an embodiment, it is determined whether the number of second target training samples (second remaining samples) excluding the second type of training sample is greater than or equal to the second number difference. If so, it indicates that sufficient training samples exist in the second remaining samples to supplement the second type of training sample. In this case, the second target training samples are extracted from the second remaining samples according to the second number difference and supplemented into the second type of training sample.

For example, assuming that the number of second remaining samples is 30 and the second number difference is 10, then 10 second target training samples are extracted from the first remaining samples and supplemented into the second type of training sample.
(2) If not, sample simulation is performed according to attribute information of the second type of training sample to generate second simulated samples.

If the number of second remaining samples is less than the second number difference, it indicates that training samples are insufficient in the second remaining samples to supplement the second type of training sample. This situation often occurs in the early phase of model training, where the performance of the large language model to be trained is poor, resulting in a larger number of first target training samples but fewer second target training samples. In this case, it is necessary to generate additional second simulation samples to supplement the second type of training sample. The number of second simulated samples is equal to the second number difference, and the attribute information includes at least one of a sample topic, sample content, or a sample format.

In an embodiment, the attribute information of each of the second type of training sample is determined, and a sample simulation method is used to perform sample simulation according to the attribute information to generate second simulated samples similar in attribute information to each of the second type of training sample.

In another embodiment, each of the second type of training sample and sample simulation instructions are input into a data generation model, and the second simulated samples are automatically output using the data generation model. The sample simulation instructions are used to guide the data generation model in acquiring the attribute information of each of the first type of training sample.
(3) The second simulated samples are supplemented into the second type of training sample to generate the fourth type of training sample.

It is determined whether the number of second remaining samples is greater than or equal to the second number difference; where the second remaining samples are second target training samples excluding the second type of training sample. If not, sample simulation is performed according to attribute information of the second type of training sample to generate second simulated samples. The number of second simulated samples is equal to the second number difference, and the attribute information includes at least one of a sample topic, sample content, or a sample format. The second simulated samples are supplemented into the second type of training sample to generate the fourth type of training sample. In this manner, it is ensured that when training samples are insufficient in the second remaining samples to supplement the second type of training sample, additional second simulated samples are generated to ensure that the expanded sample number meets the minimum number of training samples required for training. Meanwhile, it is also ensured that the ratio of the two types of training samples in the training dataset remains in the preset ratio, thereby ensuring the model training performance of the large language model to be trained.

In S304, the training dataset is constructed according to the third type of training sample and the fourth type of training sample.

It is determined whether the sum of the first number and the second number meets a target number. The target number is the minimum number of training samples required for training the large language model to be trained. If not, a first number difference between the first number and a third number and a second number difference between the second number and a fourth number are determined. The third number and the fourth number are determined according to the target number and the preset ratio. The first type of training sample is supplemented according to the first number difference to generate a third type of training sample, and the second type of training sample is supplemented according to the second number difference to generate a fourth type of training sample. The training dataset is constructed according to the third type of training sample and the fourth type of training sample. Thus, the method achieves the effect of expanding the training samples when the number of samples does not meet the minimum number of training samples required for training and ensures that the expanded sample number meets the minimum number of training samples required for training. Meanwhile, it is also ensured that the ratio of the two types of training samples in the training dataset remains in the preset ratio, thereby ensuring the model training performance of the large language model to be trained.

Optionally, before supplementing the first simulated samples into the first type of training sample, the method also includes the following:

A first semantic similarity is determined between the first simulated samples and the first type of training sample and between the first simulated samples and the second type of training sample.

Semantic similarity reflects the degree of semantic resemblance.

In an embodiment, a preset algorithm is used to calculate the first semantic similarity between each first simulated sample and the first and second types of training samples, such as using the ROUGE method.

Supplementing the first simulated samples into the first type of training sample includes the following:

In the case where the first semantic similarity is less than a similarity threshold, the first simulated samples are supplemented into the first type of training sample.

In an embodiment, if the first semantic similarity between any first simulated sample and the first and second types of training samples is greater than a similarity threshold, it indicates that a semantically similar sample exists among the first and second types of training samples; thus, that first simulated sample is discarded. If the first semantic similarity between any first simulated sample and the first and second types of training samples is less than or equal to the similarity threshold, it indicates that no semantically similar sample exists among the first and second types of training samples; thus, the first simulated sample is supplemented into the first type of training sample.

A first semantic similarity is determined between the first simulated samples and the first type of training sample and between the first simulated samples and the second type of training sample. In the case where the first semantic similarity is less than a similarity threshold, the first simulated samples are supplemented into the first type of training sample. Thus, the diversity of training samples is ensured.

Optionally, before supplementing the second simulated samples into the second type of training sample, the method also includes the following:

A second semantic similarity is determined between the second simulated samples and the first type of training sample and between the second simulated samples and the second type of training sample.

In an embodiment, a preset algorithm is used to calculate the second semantic similarity between each second simulated sample and the first and second types of training samples, such as using the ROUGE method.

Supplementing the second simulated samples into the second type of training sample includes the following:

In the case where the second semantic similarity is less than a similarity threshold, the second simulated samples are supplemented into the second type of training sample.

In an embodiment, if the second semantic similarity between any second simulated sample and the first and second types of training samples is greater than a similarity threshold, it indicates that a semantically similar sample exists among the first and second types of training samples; thus, that second simulated sample is discarded. If the second semantic similarity between any first simulated sample and the first and second types of training samples is less than or equal to the similarity threshold, it indicates that no semantically similar sample exists among the first and second types of training samples; thus, the second simulated sample is supplemented into the second type of training sample.

A second semantic similarity is determined between the second simulated samples and the first type of training sample and between the second simulated samples and the second type of training sample. In the case where the second semantic similarity is less than a similarity threshold, the second simulated samples are supplemented into the second type of training sample. Thus, the diversity of training samples is ensured.

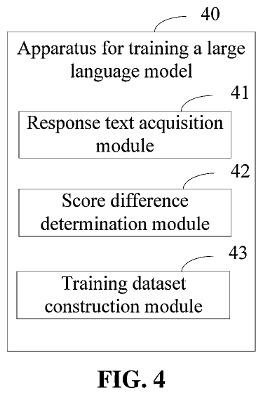

FIG. 4 is a diagram illustrating the structure of an apparatus for training certain large language models according to an embodiment of the present disclosure. This apparatus is applicable to situations where training samples generated by a pre-trained large language model are used for training a large language model to be trained. The apparatus in this embodiment may be implemented by software and/or hardware and integrated into any electronic device having a computing capability.

As shown in FIG. 4, the apparatus 40 for training a large language model disclosed in this embodiment may include a response text acquisition module 41, a score difference determination module 42, and a training dataset construction module 43.

The score difference determination module 42 is specifically configured to perform the operations described below.

A standard response text obtained by inputting any sample text instruction into the target large language model is used as a first response text, and a predicted response text obtained by inputting the any sample text instruction into the large language model to be trained is used as a second response text.

The score difference between a first quality score of the first response text and a second quality score of the second response text is used as a score difference to be evaluated.

In the case where the score difference to be evaluated is greater than a score difference threshold, the first response text is used as the first sample response text.

The apparatus also includes a quality scoring module specifically configured to perform the operations described below.

The first response text and the any sample text instruction are input into a quality scoring model to obtain a first initial score, and the second response text and the any sample text instruction are input into the quality scoring model to obtain a second initial score.

The second response text and the any sample text instruction are input into the quality scoring model to obtain a third initial score, and the first response text and the any sample text instruction are input into the quality scoring model to obtain a fourth initial score.

The first quality score is determined according to the average of the first initial score and the fourth initial score, and the second quality score is determined according to the average of the second initial score and the third initial score.

The training dataset construction module 43 is specifically configured to perform the operations described below.

Standard response texts excluding the first sample response text are used as second sample response texts, and second target training samples are generated according to the second sample response texts and sample text instructions corresponding to the second sample response texts.

A first number of first target training samples are extracted as a first type of training sample, and a second number of second target training samples are extracted as a second type of training sample. The ratio between the first number and the second number is a preset ratio.

The training dataset is constructed according to the first type of training sample and the second type of training sample.

Optionally, the training dataset construction module 43 is also specifically configured to perform the operations described below.

It is determined whether the sum of the first number and the second number meets a target number. The target number is a minimum number of training samples required for training the large language model to be trained.

If not, a first number difference between the first number and a third number and a second number difference between the second number and a fourth number are determined. The third number and the fourth number are determined according to the target number and the preset ratio.

The first type of training sample is supplemented according to the first number difference to generate a third type of training sample, and the second type of training sample is supplemented according to the second number difference to generate a fourth type of training sample.

The training dataset is constructed according to the third type of training sample and the fourth type of training sample.

Optionally, the training dataset construction module 43 is also specifically configured to perform the operations described below.

It is determined whether the number of first remaining samples is greater than or equal to the first number difference, where the first remaining samples are first target training samples excluding the first type of training sample.

If not, sample simulation is performed according to attribute information of the first type of training sample to generate first simulated samples. The number of first simulated samples is equal to the first number difference, and the attribute information includes at least one of a sample topic, sample content, or a sample format.

The first simulated samples are supplemented into the first type of training sample to generate the third type of training sample.

Optionally, the training dataset construction module 43 is also specifically configured to perform the operations described below.

It is determined whether the number of second remaining samples is greater than or equal to the second number difference; where the second remaining samples are second target training samples excluding the second type of training sample.

If not, sample simulation is performed according to attribute information of the second type of training sample to generate second simulated samples. The number of second simulated samples is equal to the second number difference, and the attribute information includes at least one of a sample topic, sample content, or a sample format.

The second simulated samples are supplemented into the second type of training sample to generate the fourth type of training sample.

Optionally, the apparatus also includes a first similarity calculation module specifically configured to perform operations described below.

A first semantic similarity is determined between the first simulated samples and the first type of training sample and between the first simulated samples and the second type of training sample.

The training dataset construction module 43 is also specifically configured to perform the operation described below.

In the case where the first semantic similarity is less than a similarity threshold, the first simulated samples are supplemented into the first type of training sample.

Optionally, the apparatus also includes a second similarity calculation module specifically configured to perform the operation described below.

A second semantic similarity is determined between the second simulated samples and the first type of training sample and between the second simulated samples and the second type of training sample.

The training dataset construction module 43 is also specifically configured to perform the operation described below.

In the case where the second semantic similarity is less than a similarity threshold, the second simulated samples are supplemented into the second type of training sample.

Optionally, the apparatus also includes a pre-training module specifically configured to perform operations described below.

At least one initial text instruction is input into the target large language model to obtain at least one initial response text.

A cold start training sample is generated according to the at least one initial text instruction and the at least one initial response text, and the cold start training sample is used to pre-train the large language model to be trained.

Optionally, the preset ratio is one to one.

The apparatus 40 for training a large language model according to embodiments of the present disclosure can perform the methods for training a large language model according to embodiments of the present disclosure and has functional modules and beneficial effects corresponding to the methods. For content not described in detail in this embodiment, reference may be made to description in method embodiments of the present disclosure.

Operations, including acquisition, storage, and application, on a user's personal information involved in the solution of the present disclosure conform to relevant laws and regulations and do not violate the public policy doctrine.

According to an embodiment of the present disclosure, the present disclosure also provides an electronic device, a readable storage medium, and a computer program product.

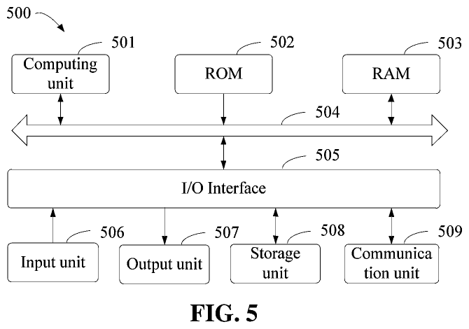

FIG. 5 is a block diagram illustrating an exemplary electronic device 500 that may be configured to perform embodiments of the present disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of the present disclosure as described and/or claimed herein.

As shown in FIG. 5, the device 500 includes a computing unit 501. The computing unit 501 may perform various types of appropriate operations and processing based on a computer program stored in a read-only memory (ROM) 502 or a computer program loaded from a storage unit 508 to a random-access memory (RAM) 503. Various programs and data required for operations of the device 500 may also be stored in the RAM 503. The computing unit 501, the ROM 502, and the RAM 503 are connected to each other by a bus 504. An input/output (I/O) interface 505 is also connected to the bus 504.

Multiple components in the device 500 are connected to the I/O interface 505. The multiple components include an input unit 506 such as a keyboard and a mouse, an output unit 507 such as various types of displays and speakers, the storage unit 508 such as a magnetic disk and an optical disk, and a communication unit 509 such as a network card, a modem or a wireless communication transceiver. The communication unit 509 allows the device 500 to exchange information/data with other devices over a computer network such as the Internet and/or various telecommunications networks.

The computing unit 501 may be various general-purpose and/or special-purpose processing components having processing and computing capabilities. Examples of the computing unit 501 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 501 executes various methods and processing described above, such as the method for training a large language model. For example, in some embodiments, the method for training a large language model may be implemented as a computer software program tangibly contained in a machine-readable medium such as the storage unit 508. In some embodiments, part or all of computer programs may be loaded and/or installed on the device 500 via the ROM 502 and/or the communication unit 509. When the computer programs are loaded into the RAM 503 and executed by the computing unit 501, one or more steps of the preceding method for training a large language model may be performed. Alternatively, in other embodiments, the computing unit 501 may be configured, in any other suitable manner (for example, by means of firmware), to execute the method for training a large language model.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs may be executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementation of the methods of the present disclosure may be written in one programming language or any combination of multiple programming languages. The program codes may be provided for the processor or controller of a general-purpose computer, a special-purpose computer or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program that is used by or used in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, a server of a distributed system, or a server combined with a blockchain.

It is to be understood that various forms of the preceding flows may be used with steps reordered, added, or removed. For example, the steps described in the present disclosure may be executed in parallel, in sequence or in a different order as long as the desired results of the technical solutions disclosed in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. A method for training a large language model, comprising:
inputting at least one sample text instruction into a target large language model to obtain at least one standard response text, and inputting the at least one sample text instruction into a large language model to be trained to obtain at least one predicted response text, wherein the target large language model is a pre-trained large language model;
determining a first sample response text from the at least one standard response text according to a score difference between a first quality score of a standard response text of the at least one standard response text and a second quality score of a predicted response text of the at least one predicted response text; and
generating a first target training sample according to the first sample response text and a sample text instruction of the at least one sample text instruction corresponding to the first sample response text, and constructing a training dataset according to the first target training sample, wherein the training dataset is used to train the large language model to be trained.

2. The method of claim 1, wherein determining the first sample response text comprises:
using a standard response text obtained by inputting any sample text instruction of the at least one sample text instruction into the target large language model as a first response text, and using a predicted response text obtained by inputting the any sample text instruction into the large language model to be trained as a second response text;
determining a score difference between a first quality score of the first response text and a second quality score of the second response text as a score difference to be evaluated; and
after determining that the score difference to be evaluated is greater than a score difference threshold, using the first response text as the first sample response text.

3. The method of claim 2, further comprising:
prior to determining the score difference:
inputting the first response text and the any sample text instruction into a quality scoring model to obtain a first initial score, and inputting the second response text and the any sample text instruction into the quality scoring model to obtain a second initial score;
inputting the second response text and the any sample text instruction into the quality scoring model to obtain a third initial score, and inputting the first response text and the any sample text instruction into the quality scoring model to obtain a fourth initial score; and
determining the first quality score according to an average of the first initial score and the fourth initial score, and determining the second quality score according to an average of the second initial score and the third initial score.

4. The method of claim 1, wherein constructing the training dataset according to the first target training sample comprises:
using standard response texts of the at least one standard response text, excluding the first sample response text, as second sample response texts, and generating second target training samples according to the second sample response texts and sample text instructions corresponding to the second sample response texts;
extracting a first number of first target training samples as a first type of training sample, and extracting a second number of second target training samples as a second type of training sample, wherein a ratio between the first number and the second number is a preset ratio; and
constructing the training dataset according to the first type of training sample and the second type of training sample.

5. The method of claim 4, wherein constructing the training dataset according to the first type of training sample and the second type of training sample comprises:
determining whether a sum of the first number and the second number meets a target number, wherein the target number is a minimum number of training samples required for training the large language model to be trained;
after determining that the sum of the first number and the second number does not meet the target number, determining a first number difference between the first number and a third number, and a second number difference between the second number and a fourth number, wherein the third number and the fourth number are determined according to the target number and the preset ratio;
supplementing the first type of training sample according to the first number difference to generate a third type of training sample, and supplementing the second type of training sample according to the second number difference to generate a fourth type of training sample; and
constructing the training dataset according to the third type of training sample and the fourth type of training sample.

6. The method of claim 5, wherein supplementing the first type of training sample according to the first number difference to generate the third type of training sample comprises:
determining whether a number of first remaining samples is greater than or equal to the first number difference, wherein the first remaining samples are first target training samples excluding the first type of training sample;
after determining that the number of first remaining samples is less than the first number difference, performing sample simulation according to attribute information of the first type of training sample to generate first simulated samples, wherein a number of first simulated samples is equal to the first number difference, and the attribute information comprises at least one of a sample topic, sample content, or a sample format; and
supplementing the first simulated samples into the first type of training sample to generate the third type of training sample.

7. The method of claim 5, wherein supplementing the second type of training sample according to the second number difference to generate the fourth type of training sample comprises:
determining whether a number of second remaining samples is greater than or equal to the second number difference, wherein the second remaining samples are second target training samples excluding the second type of training sample;
after determining that the number of second remaining samples is less than the second number difference, performing sample simulation according to attribute information of the second type of training sample to generate second simulated samples, wherein a number of second simulated samples is equal to the second number difference, and the attribute information comprises at least one of a sample topic, sample content, or a sample format; and
supplementing the second simulated samples into the second type of training sample to generate the fourth type of training sample.

8. The method of claim 6, further comprising:
prior to supplementing the first simulated samples into the first type of training sample:
determining a first semantic similarity between the first simulated samples and the first type of training sample and between the first simulated samples and the second type of training sample; and
supplementing the first simulated samples into the first type of training sample comprises:
in response to the first semantic similarity is less than a similarity threshold, supplementing the first simulated samples into the first type of training sample.

9. The method of claim 7, further comprising:
prior to supplementing the second simulated samples into the second type of training sample, determining a second semantic similarity between the second simulated samples and the first type of training sample and between the second simulated samples and the second type of training sample,
wherein supplementing the second simulated samples into the second type of training sample comprises:
after determining that the second semantic similarity is less than a similarity threshold, supplementing the second simulated samples into the second type of training sample.

10. The method of claim 1, further comprising:
prior to inputting the at least one sample text instruction into the large language model to be trained to obtain the at least one predicted response text:
inputting at least one initial text instruction into the target large language model to obtain at least one initial response text; and
generating a cold start training sample according to the at least one initial text instruction and the at least one initial response text, and using the cold start training sample to pre-train the large language model to be trained.

11. The method of claim 4, wherein the preset ratio is one to one.

12. An apparatus for training a large language model, comprising at least one processor and a memory communicatively connected to the at least one processor, wherein the memory stores processor-executable programs, and the processor-executable programs comprise:
a response text acquisition module configured to input at least one sample text instruction into a target large language model to obtain at least one standard response text and input the at least one sample text instruction into a large language model to be trained to obtain at least one predicted response text, wherein the target large language model is a pre-trained large language model;
a score difference determination module configured to determine a first sample response text from the at least one standard response text according to a score difference between a first quality score of a standard response text of the at least one standard response text and a second quality score of a predicted response text of the at least one predicted response text; and
a training dataset construction module configured to generate a first target training sample according to the first sample response text and a sample text instruction of the at least one sample text instruction corresponding to the first sample response text and construct a training dataset according to the first target training sample, wherein the training dataset is used to train the large language model to be trained.

13. The apparatus of claim 12, wherein the score difference determination module is further configured to:
use a standard response text obtained by inputting any sample text instruction of the at least one sample text instruction into the target large language model as a first response text, and use a predicted response text obtained by inputting the any sample text instruction into the large language model to be trained as a second response text;
determine a score difference between a first quality score of the first response text and a second quality score of the second response text as a score difference to be evaluated; and
after determining that the score difference to be evaluated is greater than a score difference threshold, use the first response text as the first sample response text.

14. The apparatus of claim 13, further comprising a quality scoring module configured to:
input the first response text and the any sample text instruction into a quality scoring model to obtain a first initial score and input the second response text and the any sample text instruction into the quality scoring model to obtain a second initial score;
input the second response text and the any sample text instruction into the quality scoring model to obtain a third initial score and input the first response text and the any sample text instruction into the quality scoring model to obtain a fourth initial score; and
determine the first quality score according to an average of the first initial score and the fourth initial score and determine the second quality score according to an average of the second initial score and the third initial score.

15. The apparatus of claim 12, wherein the training dataset construction module is further configured to:
use standard response texts of the at least one standard response text, excluding the first sample response text, as second sample response texts and generate second target training samples according to the second sample response texts and sample text instructions corresponding to the second sample response texts;
extract a first number of first target training samples as a first type of training sample and extract a second number of second target training samples as a second type of training sample, wherein a ratio between the first number and the second number is a preset ratio; and
construct the training dataset according to the first type of training sample and the second type of training sample.

16. The apparatus of claim 15, wherein the training dataset construction module is further configured to:
determine whether a sum of the first number and the second number meets a target number, wherein the target number is a minimum number of training samples required for training the large language model to be trained;
after determining that the sum of the first number and the second number does not meet the target number, determine a first number difference between the first number and a third number, and a second number difference between the second number and a fourth number, wherein the third number and the fourth number are determined according to the target number and the preset ratio;
supplement the first type of training sample according to the first number difference to generate a third type of training sample and supplement the second type of training sample according to the second number difference to generate a fourth type of training sample; and
construct the training dataset according to the third type of training sample and the fourth type of training sample.

17. The apparatus of claim 16, wherein the training dataset construction module is further configured to:
determine whether a number of first remaining samples is greater than or equal to the first number difference, wherein the first remaining samples are first target training samples excluding the first type of training sample;
after determining that the number of first remaining samples is less than the first number difference, perform sample simulation according to attribute information of the first type of training sample to generate first simulated samples, wherein a number of first simulated samples is equal to the first number difference, and the attribute information comprises at least one of a sample topic, sample content, or a sample format; and
supplement the first simulated samples into the first type of training sample to generate the third type of training sample.

18. The apparatus of claim 16, wherein the training dataset construction module is further configured to:
determine whether a number of second remaining samples is greater than or equal to the second number difference, wherein the second remaining samples are second target training samples excluding the second type of training sample;
after determining that the number of second remaining samples is less than the second number difference, perform sample simulation according to attribute information of the second type of training sample to generate second simulated samples, wherein a number of second simulated samples is equal to the second number difference, and the attribute information comprises at least one of a sample topic, sample content, or a sample format; and
supplement the second simulated samples into the second type of training sample to generate the fourth type of training sample.

19. The apparatus of claim 12, further comprising a pre-training module specifically configured to:
input at least one initial text instruction into the target large language model to obtain at least one initial response text; and
generate a cold start training sample according to the at least one initial text instruction and the at least one initial response text and use the cold start training sample to pre-train the large language model to be trained.

20. A non-transitory computer-readable storage medium storing computer instructions for causing a computer to perform a method for training a large language model, wherein the method for training a large language model comprises:
inputting at least one sample text instruction into a target large language model to obtain at least one standard response text, and inputting the at least one sample text instruction into a large language model to be trained to obtain at least one predicted response text, wherein the target large language model is a pre-trained large language model;
determining a first sample response text from the at least one standard response text according to a score difference between a first quality score of a standard response text of the at least one standard response text and a second quality score of a predicted response text of the at least one predicted response text; and
generating a first target training sample according to the first sample response text and a sample text instruction of the at least one sample text instruction corresponding to the first sample response text, and constructing a training dataset according to the first target training sample, wherein the training dataset is used to train the large language model to be trained.
